(19) United States
(12) Patent Application Publication
(10) Pub. No.: US 2026/0001989 A1
(43) Pub. Date: Jan. 1, 2026

(54) CONDENSATION TYPE NON-ISOCYANATE POLYURETHANE COMPOSITION

(71) Applicant: FAR EASTERN NEW CENTURY CORPORATION, Taipei City (TW)

(72) Inventors: Ken-Yuan CHANG, Taipei City (TW); Cheng-Ting WANG, Taipei City (TW); Wei-Che HUNG, Taipei City (TW)

(21) Appl. No.: 18/758,594

(22) Filed: Jun. 28, 2024

(51) Int. Cl. C08G 71/04

(52) U.S. Cl. CPC C08G 71/04

(57) ABSTRACT

A condensation type non-isocyanate polyurethane composition includes a first polyurethane represented by Formula (I) and a second polyurethane represented by Formula (II) in a molar ratio of the first polyurethane and to the second polyurethane ranging from 20:80 to 80:20, wherein each of the substituents in Formula (I) and Formula (II) is given the definitions as set forth in the Specification and Claims. The condensation type non-isocyanate polyurethane composition has an amine value of at least 10 meq/kg.

### FIELD

The present disclosure relates to a polyurethane composition, and more particularly to a condensation type non-isocyanate polyurethane composition.

### BACKGROUND

A conventional polyurethane is generally prepared using isocyanate and polyol as raw materials. In the manufacturing process of the conventional polyurethane, not only the isocyanate is itself toxic, but also requires use of another more toxic raw material, which is phosgene. Therefore, the industry actively pursues the concept of green manufacturing in the manufacturing process of non-isocyanate polyurethane composition (NIPU).

In the concept of green manufacturing, NIPU is mainly manufactured by a poly-addition process or a polycondensation process in which the structures of products obtained are different from each other.

US20230183423 A1 discloses that NIPU may be prepared by subjecting multiple cyclic carbonate and polyamine to an addition polymerization process. The thus synthesized NIPU has (—OH) functional groups on side chains thereof, and hence is known as polyhydroxyurethane (PHU) with a chemical structure represented by

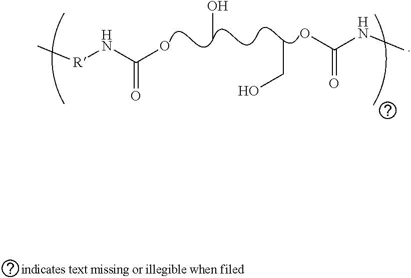

Due to the presence of abundant hydrogen bonding forces between PHU molecules, high molecular weight PHU products are difficult to obtain by addition polymerization, and thus the structural strength of PHU is not optimal.

In contrast, a condensation polymerization process generally involves reacting diamine and carbonate, followed by a transesterification reaction with polyol so as to obtain NIPU. Thus, the NIPU synthesized by the condensation polymerization process does not have side chains containing (—OH) functional groups, indicating that the chemical structure of such NIPU is different from that of PHU as described above.

CN 101696271 A, CN 103865059 A, CN 116355210 A, CN 112853531 A, and CN 104513393 B each discloses use of carbonate and diamine to prepare a dicarbamate monomer (i.e., a type of urethane diol), followed by a polymerization reaction with polyol, so as to obtain NIPU suitable for direct melt processing. However, preparation of the dicarbamate monomer requires use of organic solvents for purification by recrystallization, causing generation of a large amount of liquid waste that needs to be recycled separately, indicating that such preparation process is energy-consuming and not environmentally friendly.

In addition, TW 201634531 A and CN 107400233 B disclose use of carbonate and diamine in a molar ratio of 1:1 to prepare polyurea; however, the chemical structures of polyurea and polyurethane are very different as shown below.

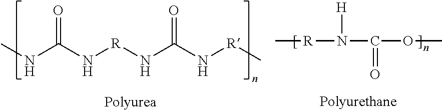

The hydrogen bonding force between polyurea molecules is very strong, and the polyurea has poor temperature resistance. For smooth processing and application of the polyurea, use of organic solvent is usually required. However, use of organic solvent will incur problems such as industrial safety concerns and recycling of liquid waste, so the industry tend to use polyurethane because polyurethane can be melt-processed and has a wide range of applications.

Although the concept of green and environmentally friendly manufacturing exist in the preparation of NIPU as mentioned above, in consideration of the processing properties (e.g., high structural strength or high melt strength) required when NIPU is subsequently used to generate products, addition of other additives (e.g., epoxy chain extender) is usually required, or in cases when NIPU is subsequently used for bonding to other materials (such as epoxy resin) to form a laminate, sufficient reactive functional groups, for example, amine-containing functional groups or sulfur-containing functional groups, are required to facilitate adhesion.

For example, in the method for preparing the NIPU as disclosed in the aforesaid CN 104513393 B, since a purification step is required after generation of the intermediate product, the active functional groups present in the NIPU are insufficient to facilitate adhesion of the NIPU to other materials. In addition, as exemplified in the method for preparing the NIPU as disclosed in CN 104910348 B and CN 116903854 A, the only intermediate product to be subsequently reacted with diol is dimethylcarbamate (i.e., a dicarbamate), which will inhibit the generation of active functional groups during the reaction with diol to form a prepolymer, and hence incurs the problems of insufficient active functional groups and difficulty in adhesion.

### SUMMARY

Therefore, an object of the present disclosure is to provide a condensation type non-isocyanate polyurethane composition that can alleviate at least one of the drawbacks of the prior art.

According to the present disclosure, the condensation type non-isocyanate polyurethane composition includes a first polyurethane represented by Formula (I) and a second polyurethane represented by Formula (II) in a molar ratio of the first polyurethane to the second polyurethane ranging from 20:80 to 80:20,

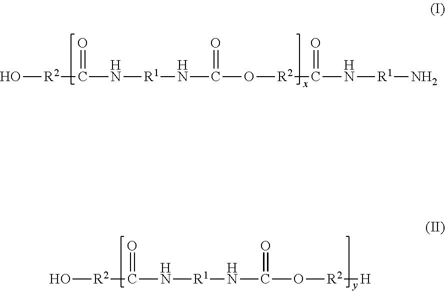

wherein
x is an integer ranging from 2 to 100;
y is an integer ranging from 2 to 100;
R¹ is a hydrocarbylene group of C₂ to C₂₀; and

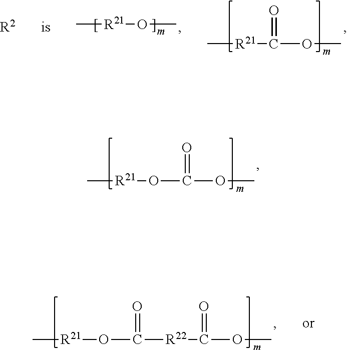

combinations thereof,
wherein
each of R²¹ and R²² is independently a hydrocarbylene group of C₂ to C₂₀; and
m is an integer ranging from 1 to 250.
   The condensation type non-isocyanate polyurethane composition has an amine value of at least 10 meq/kg.

### DETAILED DESCRIPTION

Before the present disclosure is described in greater detail, it should be noted that if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a condensation type non-isocyanate polyurethane composition including a first polyurethane represented by Formula (I) and a second polyurethane represented by Formula (II),

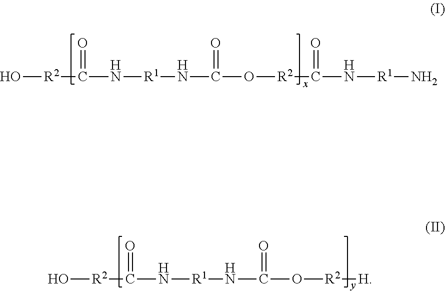

A molar ratio of the first polyurethane to the second polyurethane ranges from 20:80 to 80:20. The condensation type non-isocyanate polyurethane composition has an amine value of at least 10 meq/kg.

In Formula (I) and Formula (II), x is an integer ranging from 2 to 100; y is an integer ranging from 1 to 100; R¹ is a hydrocarbylene group of C₂ to C₂₀; and R² is

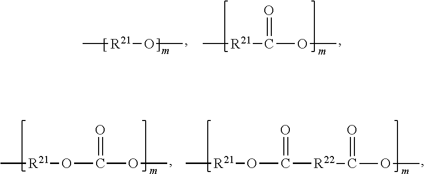

or combinations thereof, wherein each of R²¹ and R²² is independently a hydrocarbylene group of C₂ to C₂₀; and m is an integer ranging from 1 to 250. In certain embodiments, m is an integer ranging from 2 to 100.

In certain embodiments, R² is

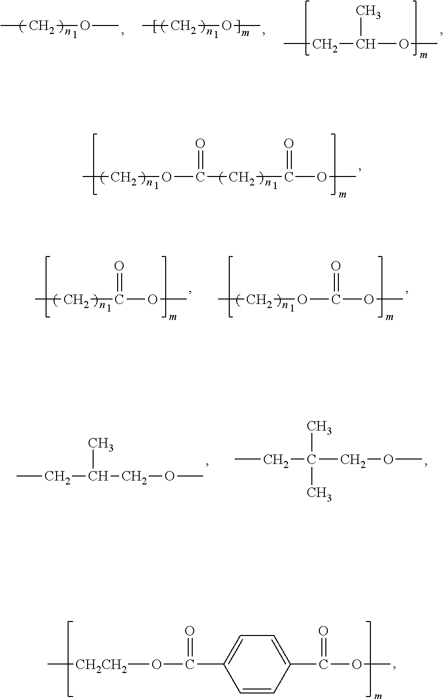

or combinations thereof, wherein n₁ is an integer ranging from 2 to 20, and m is an integer ranging from 1 to 250.

In certain embodiments, R¹ is selected from the group consisting of a cyclic hydrocarbon group, an acyclic hydrocarbon group, and a combination thereof. In certain embodiments, the cyclic hydrocarbon group is selected from the group consisting of an alicyclic hydrocarbon group, an aromatic hydrocarbon group, and a combination thereof. In certain embodiments, the acyclic hydrocarbon group is selected from the group consisting of a linear hydrocarbon group, a branch hydrocarbon group, and a combination thereof. In certain embodiments, R¹ is

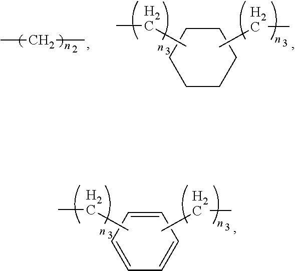

or combinations thereof, wherein n₂ is an integer ranging from 2 to 10, and n₃ is an integer ranging from 1 to 10.

In certain embodiments, the amine value of the condensation type non-isocyanate polyurethane composition ranges from 10 meq/kg to 35 meq/kg.

In certain embodiments, the molar ratio of the first polyurethane to the second polyurethane ranges from 24:76 to 76:24. In certain embodiments, the molar ratio of the first polyurethane to the second polyurethane ranges from 30:70 to 70:30.

In certain embodiments, the condensation type non-isocyanate polyurethane composition further includes an urea group-containing compound.

In certain embodiments, the urea group-containing compound is present in an amount of not less than 10 mol % based on 100 mol % of the condensation type non-isocyanate polyurethane composition. In certain embodiments, the urea group-containing compound is present in an amount ranging from 10 mol % to 35 mol % based on 100 mol % of the condensation type non-isocyanate polyurethane composition.

In certain embodiments, the urea group-containing compound may be a compound represented by Formula (V) or Formula (VI),

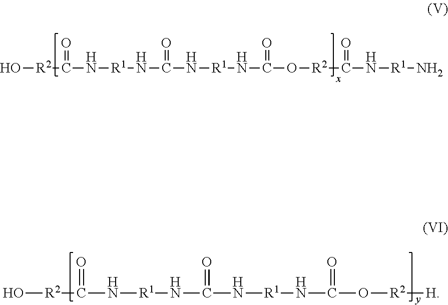

In Formula (V) and (VI), each of R¹, R², x and y are defined as mentioned in the foregoing.

In certain embodiments, an adhesion strength of the condensation type non-isocyanate polyurethane composition to an epoxy resin is at least 9 N/cm.

The present disclosure also provides a method for preparing the condensation type non-isocyanate polyurethane composition which includes subjecting a diamine compound represented by Formula (III) and a carbonate compound to a carbamation reaction so as to form a carbamate mixture that includes an amine hydrocarbamate (i.e., an amino carbamate) and a hydrocarbon in dicarbamate diester (i.e., a dicarbamate), and then subjecting the carbamate mixture and a diol compound represented by Formula (IV) to a polycondensation reaction so as to form the condensation type non-isocyanate polyurethane composition,

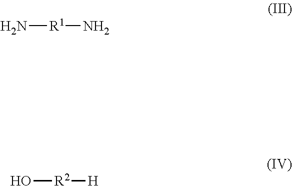

In Formula (III) and Formula (IV), R¹ is a hydrocarbylene group of C₂ to C₂₀; R² is

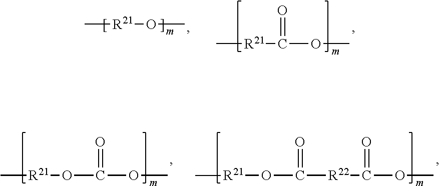

or combinations thereof, wherein each of R²¹ and R²² is independently a hydrocarbylene group of C₂ to C₂₀, and m is an integer ranging from 1 to 250.

In certain embodiments, in Formula (III) and (IV), R² is

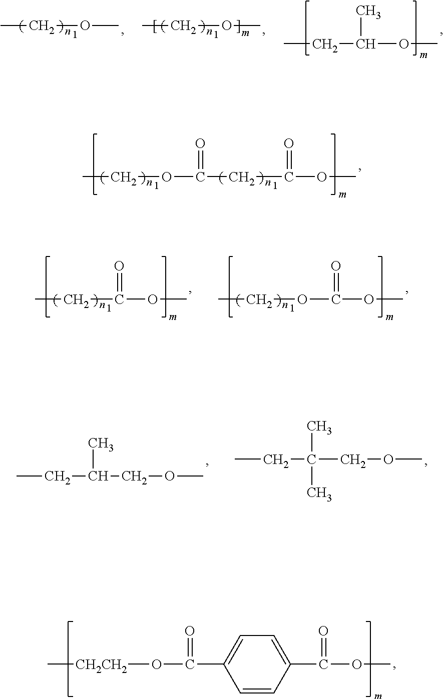

or combinations thereof, wherein n₁ is an integer ranging from 2 to 20, and m is an integer ranging from 1 to 250. In certain embodiments, m is an integer ranging from 2 to 100.

In certain embodiments, in Formula (III) and Formula (IV), R¹ is

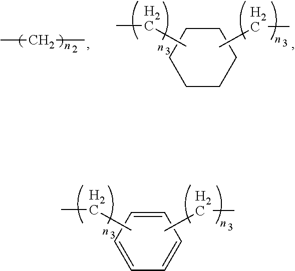

or combinations thereof, wherein n₂ is an integer ranging from 2 to 10, and n₃ is an integer ranging from 1 to 10.

In certain embodiments, the carbamation reaction is conducted at a temperature ranging from 30° C. to 120° C. In certain embodiments, the polycondensation reaction is conducted at a temperature ranging from 100° C. to 200° C.

In certain embodiments, the carbamation reaction is conducted at a pressure of approximately 760 torr. In certain embodiments, the polycondensation reaction is conducted at a pressure of not greater than 30 torr.

In certain embodiments, a molar ratio of the diamine compound to the carbonate compound ranges from 1:2 to 1:10. In certain embodiments, a molar ratio of the hydrocarbon dicarbamate diester in the carbamate mixture to the diol compound ranges from 1:0.01 to 1:2. In certain embodiments, the molar ratio of the hydrocarbon dicarbamate diester in the carbamate mixture to the diol compound ranges from 1:0.2 to 1:1.

In certain embodiments, the polycondensation reaction was conducted in the presence of a catalyst. The catalyst is selected from the group consisting of stannous chloride, dibutyltin oxide, tin oxide, zinc oxide, zinc acetate, zinc chloride, aluminum acetate, aluminum chloride, tetrabutyl titanate, tetraisopropyl titanate, and combinations thereof. In certain embodiments, the catalyst is present in an amount ranging from 0.0001 wt % to 1 wt % based on the total weight of the carbamate mixture, the diol component and the catalyst.

In certain embodiments, the diamine compound is selected from the group consisting of cyclic diamines, acyclic diamines, and a combination thereof. In certain embodiments, the diamine compound may be selected from the group consisting of pentylenediamine, hexylenediamine, decanediamine, m-phenylenediamine, 1,3-bis(aminomethyl)cyclohexane, and combinations thereof.

In certain embodiments, the diol compound is selected from the group consisting of cyclic diol, acyclic diol, and a combination thereof. In certain embodiments, the diol compound is selected from the group consisting of ether diol (e.g., polyalkyl diol), ester diol (e.g., polyester diol), carbonate diol (e.g., polycarbonate diol), and alkyl diol (e.g., alkylene diol). In certain embodiments, the diol compound is selected from the group consisting of polyethylene glycol (PEG), poly(tetramethylene ether) glycol (PTMEG), polypropylene glycol (PPG), poly(propylene-co-ethylene) glycol (PPG-co-PEG), polybutylene adipate (PBA), poly(ethylene adipate) (PEA), poly(1,6-hexamethylene adipate) (PHA), poly(butylene succinate) (PBS), poly(ε-caprolactone) (PCL), bis(2-hydroxyethyl) terephthalate (BHET) oligomer, poly(hexamethylene carbonate) diol (PHC diol), polyethylene carbonate (PEC), polypropylene carbonate (PPC), ethylene glycol (EG), propylene glycol (PG), butanediol (BDO), neopentyl glycol (NPG), 2-methyl-1,3-propanediol (MPDO), diethylene glycol (DEG), triethylene glycol (TEG), bis(2-hydroxyethyl) terephthalate (BHET), 1,4-cyclohexanedimethanol, isosorbide glycol (ISOS), tetramethylcyclobutanediol (TMCD), and combinations thereof. In certain embodiments, the diol compound has a number average molecular weight (Mn) ranging from 60 to 10000. In certain embodiments, the diol compound has a number average molecular weight (Mn) ranging from 60 to 6000.

In certain embodiments, the carbonate compound is selected from the group consisting of biomass sources, petroleum sources, recycled sources, and carbon dioxide sources.

In certain embodiments, the carbonate compound is obtained by reacting carbon dioxide and an epoxy compound.

In certain embodiments, the carbonate compound is obtained by reacting carbon dioxide, an epoxy compound, and diol.

In certain embodiments, the carbonate compound is selected from the group consisting of a cyclic carbonate, an acyclic carbonate, a polycarbonate, and combinations thereof.

In certain embodiments, the cyclic carbonate may be selected from the group consisting of ethylene carbonate (EC), propylene carbonate (PC), butylene carbonate (BC), and combinations thereof.

In certain embodiments, the acyclic carbonate may be selected from the group consisting of dimethyl carbonate (DMC), diethyl carbonate (DEC), diphenyl carbonate (DPC), substituted acyclic carbonate, and combinations thereof. An example of the substituted acyclic carbonate may be di(diethylene glycol) carbonate (DEGC).

In certain embodiments, the polycarbonate may be selected from the group consisting of polycarbonate diol, poly(ethylene carbonate), poly(propylene carbonate), and combinations thereof.

In certain embodiments, the carbamate mixture has an amine value not less than 10 meq/kg. In certain embodiments, the amine value of the carbamate mixture ranges from 10 meq/kg to 100 meq/kg.

In certain embodiments, the carbonate compound is ethylene carbonate, and the carbamate mixture includes di(2-hydroxyethyl) hydrocarbylenedicarbamate (i.e., a dicarbamate) and 2-hydroxyethyl (aminohydrocarbyl) carbamate (i.e., an amino carbamate).

In certain embodiments, the carbonate compound is dimethyl carbonate, and the carbamate mixture includes methyl(aminohydrocarbyl) carbamate (i.e., an amino carbamate) and dimethyl hydrocarbylenedicarbamate (i.e., a dicarbamate).

In certain embodiments, the carbamate mixture is not subjected to a purification step before the polycondensation reaction. In certain embodiments, the carbamate mixture is not subjected to a recrystallization step before the polycondensation reaction.

According to the present disclosure, the condensation type non-isocyanate polyurethane composition may be applied in various fields, e.g., automobiles, toys, biomedical products, electronic products, shoe materials (i.e., the entire shoe including outsole, midsole, insole, upper, etc.), sports equipment, textiles (e.g., fiber or film), and other daily necessities, or in food and construction industries, and may be used in coatings, adhesives, wires and cables, etc. It should be noted that in order to be applied in different fields, the condensation type non-isocyanate polyurethane composition may be required to have different properties.

In this regard, the condensation type non-isocyanate polyurethane composition of the present disclosure suitable for applications in different fields may be prepared by selecting different types of the diamine compound, the carbonate compound, or the diol compound.

The present disclosure will be described by way of the following examples. However, it should be understood that the following examples are intended solely for the purpose of illustration and should not be construed as limiting the present disclosure in practice.

### Preparation of Polyurethane Composition

### Example 1 (E1)

First, hexane-1,6-diamine (HMDA) (purchased from Huafon Chemical Co., Ltd., serving as a diamine compound), ethylene carbonate (EC) (purchased from Oriental Union Chemical Corporation, serving as a carbonate compound), and polyethylene gycol 1000 (PEG 1000) (purchased from Oriental Union Chemical Corporation, serving as a diol compound) were mixed at a molar ratio of 1:2.1:0.26 in a 1 L stainless steel reactor, and then subjected to a carbamation reaction at 75° C. under stirring for 5 hours, so as to obtain a carbamate mixture (including 2-hydroxyethyl (aminohexyl) carbamate, di (2-hydroxyethyl) hexamethylene dicarbamate) that had an amine value of 61.6 meq/kg which was determined according to the procedures set forth in ASTM D2074.

After adding stannous chloride (SnCl₂) (serving as a catalyst) into the aforesaid reactor, a polycondensation reaction was conducted at 180° C. and at a pressure of not greater than 30 torr for 1 hour, followed by controlling the pressure by reduction of the same to 3 torr until the product viscosity no longer increased, so as to obtain a condensation type non-isocyanate polyurethane composition of E1.

### Examples 2 (E2)

The procedures and conditions for preparing the condensation type non-isocyanate polyurethane composition of E2 were substantially similar to those of E1, except that in E2, PEG 1000 was replaced with poly(tetramethylene ether) glycol 1000 (PTMEG 1000) (purchased from Formosa Asahi Spandex Co., Ltd.), HMDA, EC and PTMEG 1000 were mixed at a molar ratio of 1:2.1:0.26, and the carbamate mixture had an amine value of 49.8 meq/kg which was determined according to the procedures set forth in ASTM D2074.

### Example 3 (E3)

The procedures and conditions for preparing the condensation type non-isocyanate polyurethane composition of E3 were substantially similar to those of E1, except that in E3, PEG 1000 was replaced with polybutylene adipate 1000 (PBA 1000) (purchased from Evermore Chemical Industry Co., Ltd.), HMDA, EC and PBA 1000 were mixed at a molar ratio of 1:2.1:0.26, and the carbamate mixture had an amine value of 48.1 meq/kg which was determined according to the procedures set forth in ASTM D2074.

### Example 4 (E4)

The procedures and conditions for preparing the condensation type non-isocyanate polyurethane composition of E4 were substantially similar to those of E1, except that in E4, PEG 1000 was replaced with poly(s-caprolactone) 2000 (PCL 2000) (purchased from Huafon Chemical Co., Ltd.), HMDA, EC and PCL 2000 were mixed at a molar ratio of 1:2.1:0.13, and the carbamate mixture had an amine value of 75.2 meq/kg which was determined according to the procedures set forth in ASTM D2074.

### Example 5 (E5)

The procedures and conditions for preparing the condensation type non-isocyanate polyurethane composition of E5 were substantially similar to those of E1, except that in E5, PEG 1000 was replaced with poly(hexamethylene) diol 1000 (PHC diol 1000) (purchased from Tosoh Corporation, product name: Nippollan 981), HMDA, EC and PHC diol 1000 were mixed at a molar ratio of 1:2.1:0.26, and the carbamate mixture had an amine value of 10.6 meq/kg which was determined according to the procedures set forth in ASTM D2074.

### Example 6 (E6)

The procedures and conditions for preparing the condensation type non-isocyanate polyurethane composition of E6 were substantially similar to those of E5, except that in E6, EC was replaced with dimethyl carbonate (DMC) (purchased from Emperor Chemical Co., Ltd.), HMDA, DMC and PHC diol 1000 were mixed at a molar ratio of 1:10:1, the carbamate mixture had an amine value of 55.1 meq/kg which was determined according to the procedures set forth in ASTM D2074, and a reflux reaction was conducted at 85° C. for 16 hours after addition of SnCl₂ and before the polycondensation reaction.

### Example 7 (E7)

The procedures and conditions for preparing the condensation type non-isocyanate polyurethane composition of E7 were substantially similar to those of E5, except that in E7, EC was replaced with diphenyl carbonate (DPC) (purchased from Emperor Chemical Co., Ltd.), HMDA, DPC and PHC diol 1000 were mixed at a molar ratio of 1:4:1, and the carbamate mixture had an amine value of 15.3 meq/kg which was determined according to the procedures set forth in ASTM D2074.

### Example 8 (E8)

The procedures and conditions for preparing the condensation type non-isocyanate polyurethane composition of E8 were substantially similar to those of E5, except that in E8, EC was replaced with di (diethylene gycol) carbonate (DEGC) (purchased from Emperor Chemical Co., Ltd.), HMDA, DEGC and PHC diol 1000 were mixed at a molar ratio of 1:4:1, and the carbamate mixture had an amine value of 32.3 meq/kg which was determined according to the procedures set forth in ASTM D2074.

### Example 9 (E9)

The procedures and conditions for preparing the condensation type non-isocyanate polyurethane composition of E9 were substantially similar to those of E5, except that in E9, HMDA was replaced with m-xylylenediamine (MXDA) (purchased from Mitsubishi Chemical Group), MXDA, EC and PHC diol 1000 were mixed at a molar ratio of 1:2.1:0.26, and the carbamate mixture had an amine value of 49.6 meq/kg which was determined according to the procedures set forth in ASTM D2074.

### Example 10 (E10)

The procedures and conditions for preparing the condensation type non-isocyanate polyurethane composition of E10 were substantially similar to those of E5, except that in E10, HMDA was replaced with 1,3-bis(aminomethyl)cyclohexane (1,3-BAC) (purchased from Mitsubishi Chemical Group), 1,3-BAC, EC and PHC diol 1000 were mixed at a molar ratio of 1:2.1:0.26, and the carbamate mixture had an amine value of 50.9 meq/kg which was determined according to the procedures set forth in ASTM D2074.

### Example 11 (E11)

The procedures and conditions for preparing the condensation type non-isocyanate polyurethane composition of E11 were substantially similar to those of E5, except that in E11, HMDA was replaced with decanediamine (DMDA) (purchased from Mitsubishi Chemical Group), DMDA, EC and PHC diol 1000 were mixed at a molar ratio of 1:2.1:0.26, and the carbamate mixture had an amine value of 25.1 meq/kg which was determined according to the procedures set forth in ASTM D2074.

### Comparative Example 1 (CE1)

The procedures and conditions for preparing the non-isocyanate polyurethane composition of CE1 were substantially similar to those of E1, except that in CE1, HMDA, EC and PEG 1000 were subjected to the carbamation reaction at 130° C. under stirring for 5 hours to obtain a carbamate mixture having an amine value of 375.6 meq/kg, which was determined according to the procedures set forth in ASTM D2074, followed by the polycondensation reaction.

### Comparative Example 2 (CE2)

First, HMDA and EC were mixed at a molar ratio of 1:2.1 in a 1 L stainless steel reactor, and then subjected to a carbamation reaction at 75° C. under stirring for 5 hours, so as to obtain a carbamate mixture. Next, the carbamate mixture was subjected to washing, filtration (to remove liquids therein) and recrystallization steps, so as to obtain an intermediate product (in a solid form) mainly composed of di (2-hydroxyethyl) hexamethylene dicarbamate having an amine value of 1.8 meq/kg, which was determined according to the procedures set forth in ASTM D2074. Afterwards, the intermediate product and PEG 1000 were mixed at a molar ratio of 1:0.26, followed by a polycondensation reaction conducted using the procedures and conditions as described in E1, so as to obtain a non-isocyanate polyurethane composition of CE2.

### Comparative Example 3 (CE3)

First, glycerol-1,2-carbonate and succinic acid were mixed at a molar ratio of 2:1 in a 1 L stainless steel reactor, and then antimony trioxide (Sb₂O₃) were added thereto, followed by an esterification reaction conducted at 180° C. and at a pressure of 15 torr for 8 hours, so as to obtain an esterification product. Thereafter, the esterification product and MXDA were mixed in a molar ratio of 1:1 under stirring, followed by a poly-addition reaction conducted at 80° C. for 8 hours, so as to obtain a non-isocyanate polyurethane composition of CE3.

### Comparative Example 4 (CE4)

Thermoplastic polyurethane (TPU) pellets purchased from Coating P. Materials Co., Ltd. (product no.: ER-80AML), which were obtained by reacting PBA and methylene diphenyl diisocyanate (MDI), directly serve as a polyurethane composition of CE4.

### Comparative Example 5 (CE5)

TPU pellets purchased from Coating P. Materials Co., Ltd. (product no.: BE-5038E), which were obtained by reacting PTMEG and MDI, directly serve as a polyurethane composition of CE5.

### Comparative Example 6 (CE6)

TPU pellets purchased from Wanhua Chemical Group Co., Ltd. (product no.: WHTA9011), which were obtained by reacting PCL and hexamethylene diisocyanate (HMDI), directly serve as a polyurethane composition of CE6.

### Comparative Example 7 (CE7)

The procedures and conditions for preparing the non-isocyanate polyurethane composition of CE7 were substantially similar to those of E6, except for the following differences. First, HMDA and DMC were reacted to obtain hexamethylene dicarbamate, which were then reacted with 1,4-butanediol (BDO) (purchased from Emperor Chemical Co., Ltd.) under a nitrogen environment at 160° C. for 2 hours, followed by addition of PHC diol 1000, such that a molar ratio of HMDA, DMC, BDO and PHC diol 1000 is 1:10:4:0.26. The carbamate mixture obtained after the carbamation reaction had an amine value of 8.9 meq/kg, which was determined according to the procedures set forth in D2074. Next, a reflux reaction was conducted at 85° C. for 16 hours after addition of SnCl₂. Thereafter, a polycondensation reaction was conducted at 180° C. and at a pressure of not greater than 30 torr for 1 hour, followed by controlling the pressure by reduction of the same to 3 torr until the product viscosity no longer increased, so as to obtain a non-isocyanate polyurethane composition of CE11.

### Property Evaluation

Each of the polyurethane compositions of E1 to E11 and CE1 to CE7 were subjected to measurements described below. The results for the measurements are listed in Table 1 below.

### 1. Amine Value

Each of the polyurethane compositions of E1 to E11 and CE1 to CE7 was subjected to measurement of amine value according to the procedures set forth in ASTM D2074.

### 2. Molecular Weight

Each of the polyurethane compositions of E1 to E11 and CE1 to CE7 was subjected to measurement of number average molecular weight (Mn) according to the procedures set forth in ASTM D3536.

### 3. Molar Ratio of Components

Each of the polyurethane compositions of E1 to E11 and CE1 to CE7 was subjected to calculation of a molar ratio of the first polyurethane (amine group is present at the end of the molecule) represented by Formula (I) to the second polyurethane (amine group is not present at the end of the molecule) represented by Formula (II) based on the aforesaid amine value and the Mn.

### 4. Adhesion Strength

First, an industrial fiber cloth (Manufacturer: Far Eastern New Century Corp.; Product no.: 4630-T2) was cut into a dimension of 10 cm×2.54 cm, and then the polyurethane compositions of E1 to E11 and CE1 to CE7 were each bonded to the industrial fiber cloth under a pressure of 3 kg at 140° C. for 1 minute. Next, the resultant polyurethane composition-containing industrial fiber cloth was immersed in 5 wt % of polyglycerol polyglycidyl ether solution (purchased from Nagase Chemtex; product no.: Denacol®EX-512), which was a cross-linking agent, for 10 minutes, followed by drying in an oven at 110° C. for 20 minutes, so as to obtain a treated polyurethane composition-containing industrial fiber cloth. At the same time, another treated polyurethane composition-containing industrial fiber cloth was prepared according to the aforesaid procedures. Thereafter, the aforesaid two pieces of the treated polyurethane composition-containing industrial fiber cloths were subjected hot-melt bonding under a pressure of 3 kg at 140° C. for 1 minute, followed by determination of adhesion strength using a tensile testing machine (Manufacturer: Instron) according to the procedures set forth in ASTM D4393.

TABLE 1

| | Molar ratio of | | Number average | Adhesion |
|---|---|---|---|---|
| | first polyurethane to | Amine value | molecular | strength |
| | second polyurethane | (meq/kg) | weight (Mₙ) | (N/cm) |
| E1 | 75.1:24.9 | 31.3 | 48000 | 9.71 |
| E2 | 56.0:44.0 | 22.4 | 50000 | 10.28 |
| E3 | 73.4:26.6 | 28.8 | 51000 | 15.78 |
| E4 | 65.9:34.1 | 26.9 | 49000 | 11.86 |
| E5 | 73.7:26.3 | 14.6 | 101000 | 12.86 |
| E6 | 50.4:49.6 | 22.9 | 44000 | 14.32 |
| E7 | 37.9:62.1 | 18.5 | 41000 | 13.88 |
| E8 | 45.3:54.7 | 19.7 | 46000 | 13.26 |
| E9 | 31.6:68.4 | 12.4 | 81000 | 11.25 |
| E10 | 28.6:71.4 | 10.6 | 94000 | 10.24 |
| E11 | 59.3:40.7 | 15.6 | 76000 | 13.09 |
| CE1 | 100.0:0.0 | 45.2 | 25000 | 1.18 |
| CE2 | 15.2:84.8 | 6.4 | 210000 | 5.87 |
| CE3 | 80.6:19.4 | 26.2 | 15000 | 0.12 |
| CE4 | 3.4:96.6 | 5.3 | 130000 | 3.11 |
| CE5 | 5.5:94.5 | 6.5 | 170000 | 2.74 |
| CE6 | 5.3:94.7 | 5.3 | 200000 | 2.35 |
| CE7 | 19.7:80.3 | 8.1 | 124000 | 7.65 |

As shown in Table 1, the condensation type non-isocyanate polyurethane compositions of E1 to E11 exhibited an amine value ranging from 10.2 meq/kg to 31.3 meq/kg, a number average molecular weight ranging from 41000 to 101000, and an adhesion strength to epoxy resin of greater than 9.71 N/cm; in contrast, the non-isocyanate polyurethane composition of CE1 exhibited an amine value of 45.2 meq/kg, the polyurethane compositions of CE2 and CE4 to CE7 exhibited an amine value of not greater than 8.1 meq/kg, the non-isocyanate polyurethane compositions of CE1 and CE3 exhibited a number average molecular weight of not greater than 25000, the polyurethane composition of CE2 and CE4 to CE7 exhibited a number average molecular weight of greater than 124000, and an adhesion strength of the polyurethane compositions of CE1 to CE7 to epoxy resin was not greater than 7.65 N/cm, indicating that the polyurethane compositions of CE1 to CE7 had insufficient adhesion to epoxy resin.

It should be noted that the non-isocyanate polyurethane composition of CE2 is substantially similar to the biodegradable thermoplastic poly(ether urethane) of CN 104513393 B. As shown in Table 2 below, the amine value of the non-isocyanate polyurethane composition of CE2, whose preparation method includes a purification step, was less than the amine value of the condensation type non-isocyanate polyurethane composition of E2, i.e., only 6.4 meq/kg, indicating that the non-isocyanate polyurethane composition of CE2 has insufficient active functional groups, resulting in the same having insufficient adhesion strength. To be specific, the method for preparing the non-isocyanate polyurethane composition of CE2 includes the purification step and a recrystallization step, such that the intermediate product obtained after the purification step only includes dicarbamate; in contrast, the purification step was omitted from the method for preparing the condensation type non-isocyanate polyurethane composition of E2, such that the intermediate product in E2 was a carbamate mixture which included dicarbamate and amino carbamate and which was directly subjected to the subsequent polymerization process (i.e., the reactants subjected to the polycondensation reaction in E2 were different from those in CE2). Therefore, after the polymerization process, the non-isocyanate polyurethane composition of CE2 would only include the second polyurethane represented by Formula (II), resulting in the non-isocyanate polyurethane composition of CE2 having insufficient active functional groups (amine groups), whereas the condensation type non-isocyanate polyurethane composition of the present disclosure includes the second polyurethane represented by Formula (II) and the first polyurethane with an amine group present at the end of the molecule and represented by Formula (I), and hence the condensation type non-isocyanate polyurethane composition of the present disclosure is provided with sufficient active functional groups so as to improve adhesive strength of the same.

TABLE 2

| | Molar ratio of | | | Adhesion |
|---|---|---|---|---|
| | first polyurethane to | Amine value | | strength |
| | second polyurethane | (meq/kg) | Mₙ | (N/cm) |
| E2 | 56.0:44.0 | 22.4 | 50000 | 10.28 |
| CE2 | 15.2:84.8 | 6.4 | 210000 | 5.87 |

It should be noted that the non-isocyanate polyurethane composition of CE7 is substantially similar to the bio-based non-isocyanate polyurethane of CN 116903854 A. As shown in Table 3 below, the amine value of the non-isocyanate polyurethane composition of CE7 was less than the amine value of the condensation type non-isocyanate polyurethane composition of E6, i.e., only 8.1 meq/kg, indicating that the non-isocyanate polyurethane composition of CE7 has insufficient active functional groups, resulting in the same having insufficient adhesion strength. To be specific, the non-isocyanate polyurethane composition of CE7 was prepared in 3 steps, in which the intermediate product was hydroxyl-terminated prepolymer, resulting in insufficient active functional groups (i.e., amine groups) at the end of the polyurethane, and hence the non-isocyanate polyurethane composition of CE7 has a relatively low adhesion strength.

TABLE 3

| | Molar ratio of | | | Adhesion |
|---|---|---|---|---|
| | first polyurethane to | Amine value | | strength |
| | second polyurethane | (meq/kg) | Mₙ | (N/cm) |
| E6 | 50.4:49.6 | 22.9 | 44000 | 14.32 |
| CE7 | 19.7:80.3 | 8.9 | 124000 | 7.65 |

In summary, by virtue of using the condensation type non-isocyanate polyurethane composition of the present disclosure and an epoxy resin to form a composite material, the adhesion strength of the condensation type non-isocyanate polyurethane composition to the epoxy resin is relatively high. In addition, the method for preparing the condensation type non-isocyanate polyurethane composition of the present disclosure would not produce a large amount of liquid waste that needs to be recycled separately. Therefore, the purpose of the present disclosure can indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A condensation type non-isocyanate polyurethane composition, comprising:
a first polyurethane represented by Formula (I) and a second polyurethane represented by Formula (II) in a molar ratio of said first polyurethane to said second polyurethane ranging from 20:80 to 80:20, 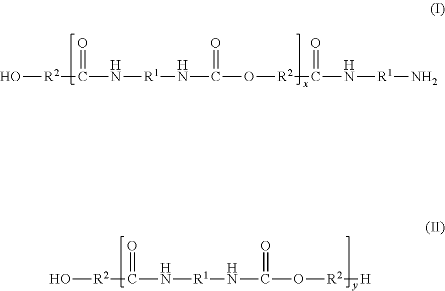
wherein
x is an integer ranging from 2 to 100;
y is an integer ranging from 2 to 100;
R¹ is a hydrocarbylene group of C₂ to C₂₀; and
R² is 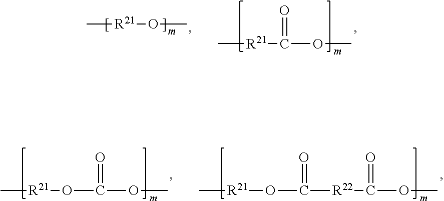
or combinations thereof,
wherein
each of R²¹ and R²² is independently a hydrocarbylene group of C₂ to C₂₀; and
m is an integer ranging from 1 to 250, and
said condensation type non-isocyanate polyurethane composition having an amine value of at least 10 meq/kg.

2. The condensation type non-isocyanate polyurethane composition as claimed in claim 1, wherein R² is 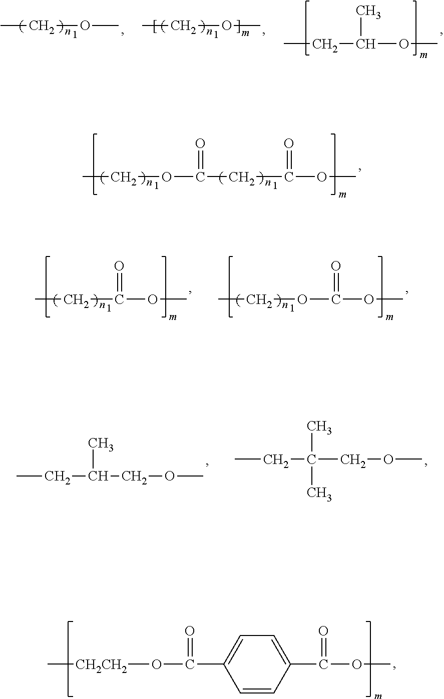
or combinations thereof,
wherein
n₁ is an integer ranging from 2 to 20; and
m is an integer ranging from 1 to 250.

3. The condensation type non-isocyanate polyurethane composition as claimed in claim 1, wherein R¹ is 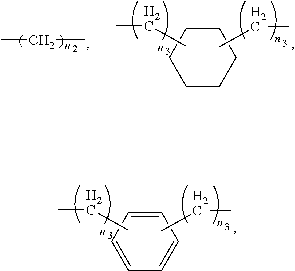
or combinations thereof, wherein n₂ is an integer ranging from 2 to 10; and n₃ is an integer ranging from 1 to 10.

4. The condensation type non-isocyanate polyurethane composition as claimed in claim 1, wherein said amine value ranges from 10 meq/kg to 35 meq/kg.

5. The condensation type non-isocyanate polyurethane composition as claimed in claim 1, wherein said molar ratio of said first polyurethane to said second polyurethane ranges from 24:76 to 76:24.

6. The condensation type non-isocyanate polyurethane composition as claimed in claim 1, wherein m is an integer ranging from 2 to 100.
